(19) United States
(12) Patent Application Publication
(10) Pub. No.: US 2004/0005394 A1
(43) Pub. Date: Jan. 8, 2004

(54) Process and apparatus for aging rum

(75) Inventor: Luis Planas-Navarro, San Juan, PR (US)

Correspondence Address: John C. McMahon, PO Box 30069, Kansas City, MO, 64112, US

(73) Assignee: Bacardi Corporation

(21) Appl. No.: 10/189,713

(22) Filed: Jul. 3, 2002

(51) Int. Cl. C12H 1/04

(52) U.S. Cl. 426/422

(57) ABSTRACT

An alcoholic beverage, such as rum, is aged in a non permeable metal container containing suspended wooden staves. During the aging process oxygen is injected into the aging beverage, so as to maintain a preselected dissolved oxygen concentration in the beverage, preferably in the range of 7.25 and 8.2 milligrams of oxygen per liter of beverage.

### BACKGROUND OF THE INVENTION

The present application is directed to a process and apparatus for aging rum and, in particular, to such a process wherein the rum is aged in a non permeable vessel.

Many alcoholic beverages require aging in order for the various constitutes thereof to chemically react and improve the quality of the beverage. This is especially true in the case of rum where aging is required to produce the desired smoothness, balance and aroma of the final product.

Traditionally, many of the alcoholic beverages have been aged in wooden casks or barrels wherein the wood of the container interacts chemically with the components of the beverage. The wood of the containers includes two major components which are cellulose and lignins. Preferably, the lignins of the wood chemically react with certain of the components of the alcoholic beverage being aged during the aging process. Other chemical reactions occur within the beverage itself and they follow a specific reaction path. The reactions that take place over time are mainly oxidation type reactions. In the aging of rum, one of the most important reactions is the chemical combination of ethanol and acidic acid to form ethyl acetate, the presence of which is critical for producing the desired balance of the final rum product. Normally, the development of various components, such as esters, tannins and organic acids is monitored over time during the aging process.

Many alcoholic beverages must be aged in the presence of certain woods, for certain lengths of time and manufactured from certain original components in order to be legally labeled a particular type of beverage. For example, rum has historically been required to be a product of the sugar cane plant, to be aged in the presence of white oak, and to be aged for one to eight years or more.

The main problem with aging of an alcoholic beverage in a wooden barrel is that the barrel has a certain degree of permeability. That is, alcohol and water within the product migrate through the wood and evaporate into the air on the outer side of the barrel. When aging in a conventional wooden barrel, as much as seven percent of the liquid contents of the barrel are lost to evaporation each year. When a product is aged for seven years or longer, as much as fourty percent of the contents of the barrel may be lost during aging.

Certain prior art references have recognized this problem in the past and have tried to resolve it by utilizing a non permeable outer container, such as steel which prevents evaporation of the contents into the air. Such prior art has suspended the wood in the aging liquid within the container so as to provide the wood needed for proper aging. The problem with this procedure is that the wood is not only permeable to evaporation from the inside out, but also allows a certain migration of oxygen to enter into the aging liquid within the container. The use of a non permeable structure prevents such migration of oxygen into the liquid.

Oxygen is a necessary requirement of the aging process, especially for rum. It is required for certain reactions that take place and a certain concentration of dissolved oxygen is required. The amount of usage of oxygen may vary over time, because different reactions may be important during different stages of the aging process. The prior art that utilized a non permeable container fails to provide oxygen for the various reactions and, therefore, may lead to an inferior product.

Consequently, it is not only desirable to provide a container that is non permeable to prevent evaporation loss, but also to provide the necessary wood and oxygen components within the container to allow for proper aging and development of the beverage.

### SUMMARY OF THE INVENTION

An apparatus and process are provided for aging a large volume of an alcoholic beverage in a single reactor without evaporation loss while maintaining high product quality. The apparatus includes a non permeable vessel or reactor, preferably constructed of metal, such as stainless steel. Also, preferably the vessel has a large volume compared to a conventional barrel of 30,000 gallons or more. A plurality of wooden planks or staves, preferably white oak, are suspended in the vessel. Further, preferably, the staves have a surface area that in total has at least the same ratio to the volume of the beverage as does the wooden surface on the interior of a conventional wooden barrel that is used for aging to the volume of the contents of the barrel.

In order to ensure that the preferred chemical reactions occur between the components of the beverage and the wood, the dissolved oxygen concentration of the beverage is continuously monitored by a probe or sensor of a monitor. An oxygen supply system, preferably including a compressor is used that draws ambient air and delivers oxygen through a porous tubing at the bottom of the reactor so that the oxygen bubbles up through the beverage. The oxygen supply system delivers oxygen to the beverage under control of the monitor, so as to maintain the dissolved oxygen concentration in the aging beverage within a preselected range. Preferably, the dissolved oxygen concentration is maintained in the range from about 7.25 to 8.2 milligrams of oxygen per liter of beverage.

### OBJECTS AND ADVANTAGES OF THE INVENTION

Therefore, the objects of the present invention are to provide an apparatus for aging an alcoholic beverage, especially rum, in a non permeable vessel or reactor so as to reduce loss of water and ethanol that migrates through walls of wooden barrels over time and then evaporates from the outer surface of the barrels; to provide such an apparatus wherein wooden staves are placed in the reactor in direct contact with the aging beverage so as to produce desired chemical reactions in the aging beverage due to contact with the wooden staves; to provide such an apparatus wherein the dissolved oxygen concentration of the aging beverage is continuously monitored by a sensor which is in turn linked to and in control of an oxygen supply system through a monitor for delivering oxygen into an interior of the reactor and into the beverage so as to maintain the dissolved oxygen concentration in the beverage in a preselected range which for rum is preferably from about 7.25 to 8.2 milligrams of oxygen per liter of beverage; to provide such an apparatus that can age a large volume, on the order of 30,000 gallons or more, of beverage in a single reactor; to provide a process for aging such a beverage utilizing the apparatus; and to provide such an apparatus and process that are comparatively inexpensive to use, substantially reduce evaporation losses, maintain high quality and are especially well adapted for the intended usage thereof.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a perspective and partially schematic view of a reactor for aging alcoholic beverages with portions broken away to show interior detail thereof.

FIG. 2 is an enlarged cross sectional and partially schematic view of the reactor illustrating interior components thereof.

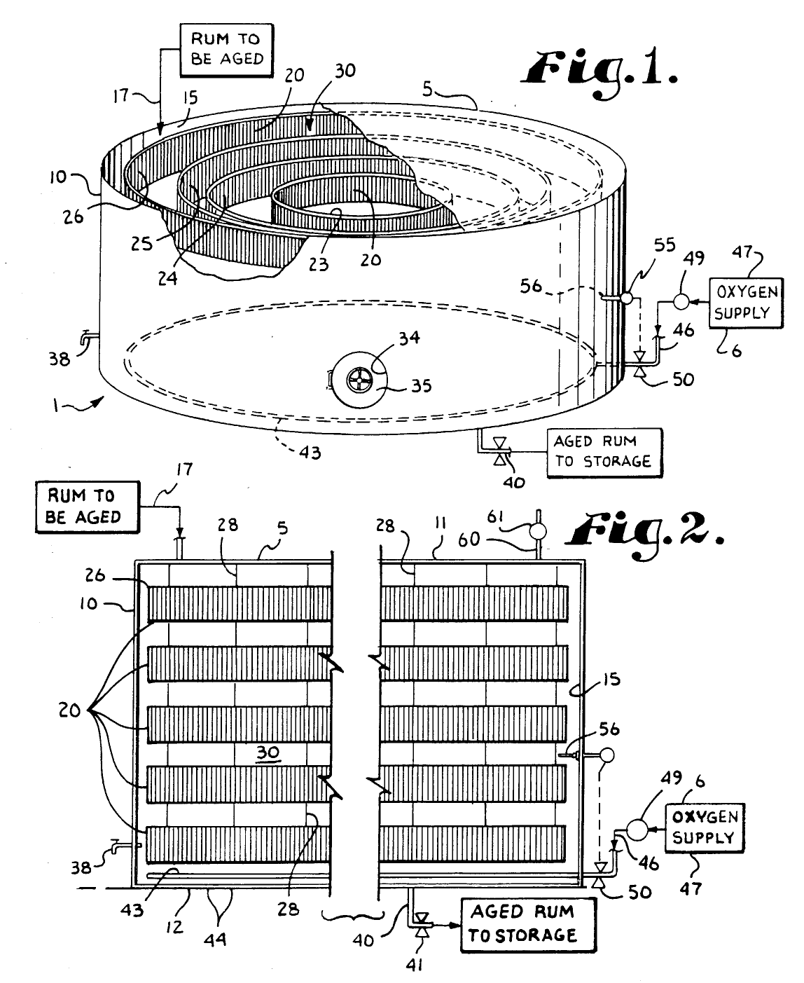

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The reference number 1 generally represents a processing apparatus for use in aging alcoholic beverages. The processing apparatus 1 generally includes an aging reactor 5 and an oxygen supply system 6.

The aging reactor 5 has an outer cylindrical wall 10 that seals with a top 11 and a bottom 12 thereof to form a fully enclosed container. The reactor outer wall 10, top 11 and bottom 12 are preferably constructed of a substantially liquid and gaseous vapor non permeable material, such as metal, including stainless steel or the like. The reactor outer wall 10, top 11 and bottom 12 form an enclosed and sealed inner chamber 15 for holding alcoholic beverages to be aged therein. Preferably, the internal size of the chamber 15 is comparatively large and it has been found that a volume of 30,000 gallons or greater is preferable. Alcoholic beverages, in the quantity of approximately 30,000 gallons or more are placed in the interior of the chamber 15 through a delivery inlet 17 and allowed to remain within the chamber 15 for at least months and preferably from one to eight years for proper aging. Alcoholic beverages, such as rum and the like contain not only ethanol and water, but also other components during the aging process, such as esters, tannins and organic acids which react with one another and reach a chemical equilibrium over time. A desired composition at the end of the aging process is decided in advance and the process is suitably modified to allow the aging to produce a preferred final composition with the flavors, smoothness, balance and aromas that are most desired for that particular alcoholic beverage.

Certain alcoholic beverages, such as rum, are required by law to be aged in touching association with certain types of wood, especially white oak. The components of the alcoholic beverage chemically interact with certain components of the wood to improve the quality of the alcoholic beverage over time. Because wooden barrels have a certain degree of permeability, over time such barrels lose a fairly substantial portion of both the water and ethanol content of the liquid held therein. Typical loss is about seven percent by volume per year which can be a majority of the starting material, if it is aged for eight years. Therefore, it is preferable in the present invention for the outer containment to be essentially or almost entirely non permeable to the components of the aging beverage so as to prevent loss of liquid or gaseous components due to such components migrating through and evaporating from the outside of a wooden container. Consequently, rather than form the container out of wood, wooden members, planks or staves 20 are placed within the chamber 15. Because of the large size of the chamber 15 many thousands of staves 20 may be placed therein.

In particular, the wooden staves 20 are hung in cylindrically configured and radial expanding groups such as groups 23, 24, 25 and 26 by wires 28 or the like from the reactor top 11. Many different configurations may be used for suspending the staves 20. The staves 20 can also be mounted on a metal frame or similar structure and it is believed that the life expectancy of the staves 20 will be about 35 years before requiring changeout. The staves 20 are located throughout the interior of the reactor 5 and a liquid 30 within the reactor 5, which is the aging beverage, is free to touchingly engage all sides of each of the staves 20. Thus, the entire surface area of each stave 20 is normally in touching contact with the liquid 30. Preferably, the surface area of staves 20 found in the reactor 5 is at least approximately proportional in ratio to the liquid 30 as compared to the volume of liquid in a standard wooden barrel verses the surface area of wood exposed to the liquid in such a barrel. It is seen that this ratio can be changed, especially by increasing the surface area, in order to improve the quality of the beverage in the large reactor 5, since the wood surface is not fixed in amount, such as is found in wooden barrels.

The reactor 5 also includes a manhole 34 covered by a door 35 to allow access to the chamber 15 by workers when cleaning the reactor 5.

One or more sampling ports 38 are located about the reactor 5 and allow an operator to procure a sample of the liquid 30 from within the chamber 15 at any time during the aging process. An outlet 40 allows liquid 30 under flow control of a valve 41 to be drained and removed from the reactor 5, when the aging process is complete.

The oxygen supply system 6 supplies oxygen to the aging reactor inner chamber 15, as required by the needs and usage of the aging process. The oxygen supply system 6 includes a dispersion tube 43 that is positioned near the reactor bottom 12 within the chamber 15 and which is porous, here including a large plurality of apertures 44 to allow oxygen from the tube 43 to bubble into and up through the liquid 30 within the chamber 15. The dispersion tube 43 is flow connected to an intermediate tube 46 which is in turn connected to an oxygen supply 47. The oxygen supply 47 may be any conventional source of oxygen and could be a tank containing liquid or compressed oxygen or compressed air. In the present embodiment a compressor 49 draws ambient air and compresses the air for transfer through to the tube 43 and subsequent distribution within the chamber 15. In the preferred embodiment, the oxygen supply is from ambient air and it is pressurized by the compressor 49. Located along the intermediate tube 46 is a control valve 50 which allows control of flow of oxygen into the chamber 15, as demanded and as described below.

An oxygen monitor or sensor 55 includes a probe 56 which is placed within the chamber 15 so as to be in touching relationship with the liquid 30 therein. The oxygen sensor 55 continuously measures and determines the dissolved oxygen concentration within the liquid 30 and compares that to a desired level. It has been found that the dissolved oxygen content of the liquid 30, when rum, is preferably maintained in the range between from about 7.25 milligrams of oxygen per liter to 8.2 milligrams of oxygen per liter; however, this concentration can be varied depending upon the desired final product. When the dissolved oxygen level within the liquid 30 reaches the lower limit in the preselected range, the oxygen sensor 55 communicates with the control valve 50 to open the valve 50 and allow oxygen to be distributed within the chamber 15. When the dissolved oxygen level exceeds 8.2 milligrams of oxygen per liter, the oxygen sensor 55 operably communicates with the valve 50 to close the control valve 50 so as to shut off oxygen from entering the chamber 15. It is foreseen that valve 50 may be controlled directly by the sensor 55 or indirectly by communicating the dissolved oxygen levels to an operator who could in turn operate the valve 50. A vent 60 with a relief valve 61 is provided to allow venting of gases, if necessary, should the gasses exceed a specified pressure within the chamber 15, especially where ambient air is used as an oxygen source and nitrogen accumulates under pressure within the reactor 5.

It is to be understood that while certain forms of the present invention have been illustrated and described herein, it is not to be limited to the specific forms or arrangement of parts described and shown.

What is claimed and desired to be secured by Letters Patent is as follows:

1. In a process for aging alcoholic beverages wherein the aging alcoholic beverage is exposed to wood for a selected period of time and wherein the aging alcoholic beverage and wood are placed in a substantially non permeable reactor; the improvement comprising:
a) maintaining a dissolved oxygen concentration within the aging alcoholic beverage within a preselected range.

2. The process according to claim 1 including:
a) wherein said alcoholic beverage is rum and maintaining said dissolved oxygen concentration in the range from about 7.25 milligrams to about 8.2 milligrams of oxygen per liter of beverage.

3. The process according to claim 1 including:
a) providing a metal reactor to hold said beverage during aging.

4. The process according to claim 3 including:
a) suspending a plurality of white oak wooden staves within said aging alcoholic beverage.

5. The process according to claim 1 including the steps of:
a) continuously monitoring the dissolved oxygen concentration of the aging alcoholic beverage with a sensor;
b) providing a source of oxygen; and
c) providing flow of oxygen from said source to said beverage based upon the concentration of dissolved oxygen in said beverage determined in step a) so as to maintain the dissolved oxygen level in the aging alcoholic beverage within said preselected range.

6. An alcoholic beverage aging apparatus comprising:
a) a containment reactor operably receiving said beverage for aging;
b) a plurality of wooden members located in said reactor and operably in touching contact with said beverage during aging; and
c) an oxygen supply system operably supplying oxygen to said beverage during aging so as to maintain dissolved oxygen levels in said aging beverage generally within a preselected range.

7. The apparatus according to claim 6 wherein:
a) said containment reactor is constructed of a substantially non permeable material with respect to said beverage.

8. The apparatus according to claim 7 wherein:
a) said reactor is constructed of stainless steel.

9. The apparatus according to claim 6 including:
a) a dissolved oxygen sensor for operably measuring the dissolved oxygen concentration in said beverage.

10. The apparatus according to claim 9 wherein:
a) said sensor is linked to said oxygen supply system and operably controls flow of oxygen from said system into said beverage to maintain dissolved oxygen concentration in said aging beverage within said preselected range.

11. The apparatus according to claim 10 wherein:
a) said dissolved oxygen concentration range is between from about 7.25 to about 8.2 milligrams of oxygen per liter of beverage.

12. The apparatus according to claim 6 wherein:
a) said wooden members are white oak staves.

13. A process for aging an alcoholic beverage including the steps of:
a) placing said beverage to be aged in a containment vessel;
b) placing wooden members in touching contact with said beverage; and
c) controlling dissolved oxygen concentration in said beverage within a preselected range during at least a portion of the aging process.

14. The process according to claim 13 including:
a) monitoring through a sensor said dissolved oxygen concentration in said beverage; and
b) linking said sensor with an oxygen supply system so as to operably supply oxygen to said beverage when required to maintain said dissolved oxygen concentration.

15. The process according to claim 13 including:
a) maintaining said dissolved oxygen concentration in the range from about 7.25 to about 8.2 milligrams of oxygen per liter of beverage.

16. An apparatus for aging rum comprising:
a) a stainless steel reactor having a capacity of at least about 30,000 gallons of rum;
b) a plurality of white oak staves suspended in said reactor so as to operably be in touching contact with said rum;
c) an oxygen sensor for operably sensing dissolved oxygen concentration in the aging rum;
d) an oxygen supply system for supplying oxygen into the aging rum;
e) said sensor being linked to said supply system and controlling said supply system so as to flow oxygen into said rum during aging to maintain dissolved oxygen concentration within the aging rum within a preselected range.

17. The apparatus according to claim 16 wherein:
a) said oxygen supply system utilizes ambient air and includes a compressor for compressing the air; said system flow communicates the compressed air with the interior of said reactor.

18. The apparatus according to claim 16 wherein:
a) said sensor operably maintains the dissolved oxygen concentration in the rum in the range from about 7.25 to about 8.2 milligrams of oxygen per liter of rum.

19. A process for aging rum including the steps of:
a) providing a non permeable container;
b) placing said rum in said container;
c) placing white oak staves in said container in touching contact with said rum; and
d) maintaining the dissolved oxygen concentration in said rum within a preselected range.

20. The process according to claim 19 including the step of:
a) maintaining the said dissolved oxygen concentration in the range from about 7.25 to about 8.2 milligrams of oxygen per liter of rum throughout substantially the entire aging process.
